(19) United States
(12) Patent Application Publication
(10) Pub. No.: US 2004/0187691 A1
(43) Pub. Date: Sep. 30, 2004

(54) Fan blade

(76) Inventor: Tai-Ching Lee, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/822,741

(22) Filed: Apr. 13, 2004

Related U.S. Application Data
(63) Continuation-in-part of application No. 10/233,303, filed on Aug. 30, 2002, now abandoned.

(51) Int. Cl. B01D 53/02

(52) U.S. Cl. 96/134

(57) ABSTRACT

A fan blade is perforated with a plurality of through holes with the surface of each hole and the blade provided with and made integrated with an active carbon filtration filter, or the perforated fan blade is made in the form of a hard net and the active carbon filtration layer is provided in each mesh of the net.

The present invention is a continuation-in-part (CIP) application of the application Ser. No. 10/233,303 filed on Aug. 20, 2002, and more particularly to a fan blade that is perforated with a plurality of through holes made integrated with the blade of active carbon filtration layer that covers upon the surfaces of the blade and each through hole, or alternatively, the blade is made in a form of a hard net perforated with a plurality of through holes.

### BACKGROUND OF THE INVENTION

(a) Field of the Invention

(b) Description of the Prior Art

In many types of fan blade of the prior art or the prior application, it can be usually observed with the structure of having incorporated the filtration layer to the external of the fan. The structure features that the filtration layer is provided externally to the space for the rotation of the fan blades, and the fan blades are used to force the air to blow through or sucked through the filtration layer to filter the air. Whereas the filtration layer will affect the air volume delivered by the fan, the filtration layer is made very slacken. As a result, the filtration effect is very poor since it only filters the larger particles in the air.

Another type of structure has the filtration layer directly provided on the fan blade by having erected vertically the filtration layer on an entirely closed fan blade or provided between any two abutted fan blades, or having provided a frame on the fan blade to accommodate the filter layer. However, this type of structure is only seen with a ceiling fan, which does not provide greater air volume or good filtration result. Furthermore, a hollow blade is also found with the ceiling fan by providing a cavity on the fan blade first with the cavity having a smaller lower part and a grater upper part sandwiching a grill to facilitate the insertion of a filtration plate; or alternatively in a comparatively complicated structure, a cavity is provided on the fan blade to accommodate the filtration layer while multiple grills in parallel are provided over the cavity with the peripheral of the filtration fixed onto the fan blade.

All the fan blades provided with filtration layers of the prior application are related to those for ceiling fans. They rotate at a slower speed, resulting in smaller centrifugal force. Consequently, the filtration layer is not vulnerable to get deformed or fall off. On the other hand, such fan blade is not working with a standing fan, since the blades of the standing fan rotate at much faster speed resulting in greater centrifugal force.

The filtration layer taught in the prior application is related only to one that is perforated with multiple holes without specifically mentioning the material of the active carbon, thus appears to be made of ordinary materials without the effects of de-odor and sterilization at the same time. In other words, the filtration layer either the prior art or the prior application does not provide de-odor and sterilization results.

### SUMMARY OF THE INVENTION

The primary purpose of the present invention is to provide to provide a fan blade that is perforated with a plurality of through holes to improve air quality of the environment. To achieve the purpose, the through holes and the blade are covered with and made integrated with an active carbon filtration layer.

Another purpose of the present invention is to provide a fan blade to achieve the purpose of improving the air quality of the environment. To achieve the purpose, the blade is made in a form of a hard net and an active carbon filtration layer is provided on the surface of each through hole and the blade.

### BRIEF DESCRIPTION OF THE DRAWINGS

FIG. 1 is a perspective view of a preferred embodiment of the present invention.

FIG. 2 is a sectional view of a fan blade of the preferred embodiment of the present invention.

FIG. 3 is a perspective view of a fan blade of another preferred embodiment of the present invention.

### DETAILED DESCRIPTION OF THE PREFERRED EMBODIMENTS

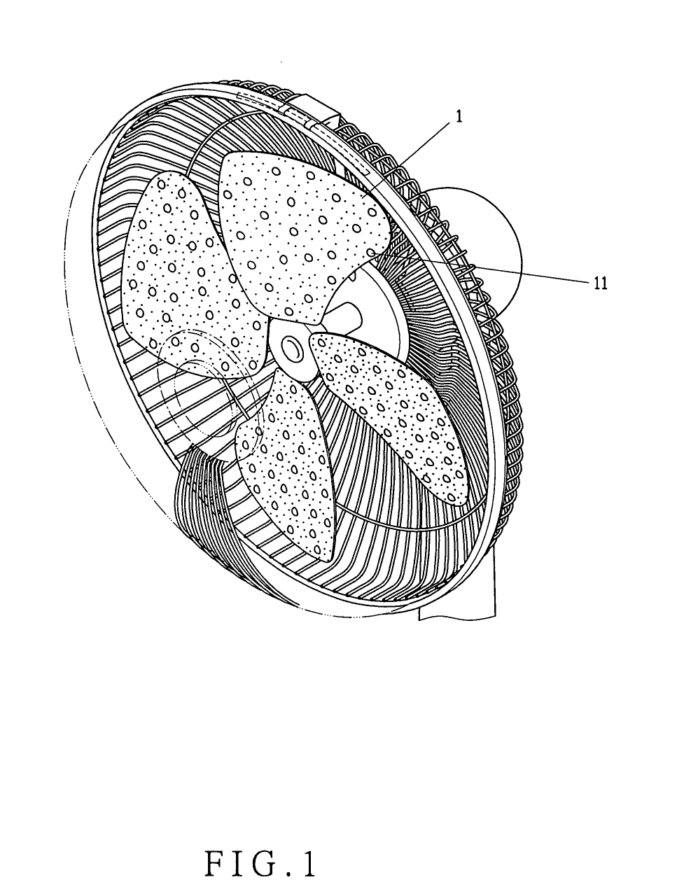

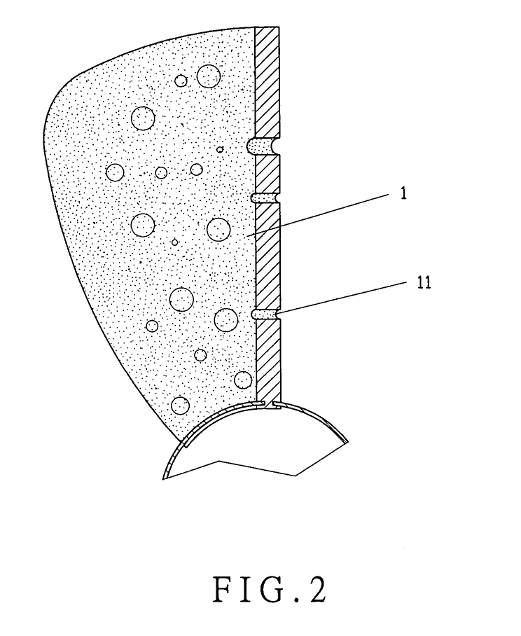

Referring to FIGS. 1 and 2, a preferred embodiment of the present invention of a fan blade (1) is made integrated in one piece of an active carbon filtration layer. The blade (1) is perforated with a plurality of through holes (11) with each in a proper size, and the active carbon filtration layer fully covers up the surface of the blade (1) and each through hole (11). When the blade (1) rotates to deliver the air from the front of the blade (1), the instantaneously negative pressure created is sucked through the rear of the blade (1) to pass through the active carbon filtration layer and then delivered to the front of the blade (1).

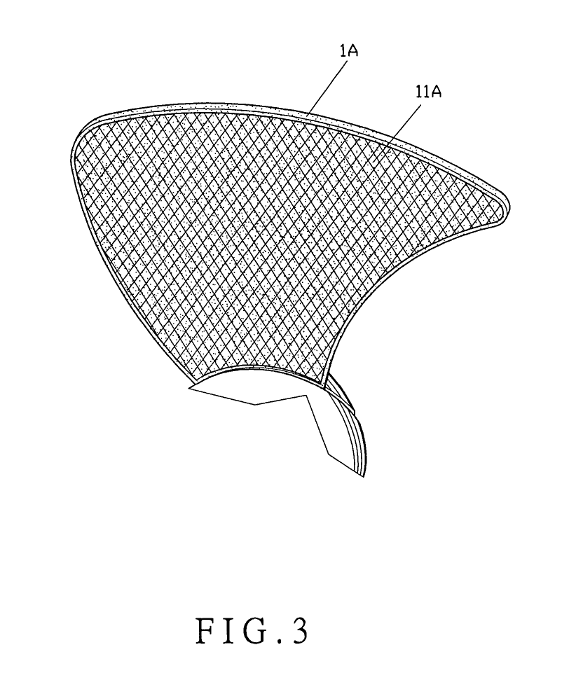

In another preferred embodiment of the present invention as illustrated in FIG. 3, a plurality of through holes (11A) are perforated on a blade (1A) made of a hard net with the active carbon filtration layer provided in each mesh of the net.

The active carbon filtration layer is made of a mixture comprised of active carbon powders, grains or fibers and pulp into a thin layer provided with gaps; or alternatively, is having the active carbon layer directly adhered to the front or the rear, or both of a base filtration material comprised of non-woven fabric, fiber layer, PE or PU foam with voids. The active carbon layer may be adhered to the base filtration material either by glue, by spraying an adhesion substance, or otherwise, while the active carbon layer may be provided in the form of powder, grain or fiber staple.

Alternatively, the active carbon filtration layer may be made of two layers of a base filtration material of non-woven fabric, fiber layer, PE or PU foam with voids with the active carbon layer adhered between; the active carbon layer may be in the form of powder, grain, or fiber staple; and both layers of the base filtration material may be glued, bound with direct heating (e.g. high-frequency binding) or otherwise; or magic tape is provided on the edge of each layer of the base filtration material to facilitate replacing the active carbon layer or cleaning the base filtration layers.

Furthermore, more than two layers of the base filtration material may be provided to the active carbon filtration layer of the present invention with the active carbon adhered between any two abutted layers of the base filtration material.

I claim:

1. A fan blade being integrated with an active carbon filtration layer; the blade being perforated with a plurality of through holes with the active carbon filtration layer covering up surfaces of each through hole and the blade.

2. A fan blade as claimed in claim 1, wherein, the blade is made in the form of a hard net and is perforated with a plurality of through holes.
